(19) United States
(12) Patent Application Publication
(10) Pub. No.: US 2010/0184428 A1
(43) Pub. Date: Jul. 22, 2010

(54) LOCAL ROAMING NUMBER SERVER

(75) Inventor: WEICAI LUO, Palo Alto, CA (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/354,980

(22) Filed: Jan. 16, 2009

(51) Int. Cl. H04W 8/04; H04W 8/06; H04W 8/08

(52) U.S. Cl. 455/433; 455/445

(57) ABSTRACT

Another embodiment is directed to a wireless network. The wireless network comprises a visitor location register to store information about wireless devices that are located in a coverage area associated with the wireless network and a switching center to establish calls with wireless devices located in the coverage area associated with the wireless network. The wireless network further comprises a home location register to store information about subscribers for whom the wireless network is their home network and an operations and support subsystem that is configured to receive information indicative of location update events. The wireless network further comprises a local roaming server coupled to the operations and support subsystem to receive at least a portion of the information indicative of the location update events. The local roaming server is configured to do the following after a visitor enters the coverage area associated with the wireless network and successfully performs a location update: store an address associated with the visitor location register that is servicing the visitor and act as a home location register in connection with providing local roaming number service to the visitor using a local roaming number assigned to the visitor.

### BACKGROUND

It is typically the case that in order for a subscriber of a “home” public land mobile network (PLMN) to use services provided by another “visited” PLMN, the operators of the two PLMNs must have entered into a “roaming agreement.” When such a subscriber is using the services of the visited PLMN, the subscriber is also referred to here as a “visitor” or a “roamer.” The negotiation and execution of a roaming agreement between the operators of the two PLMNs is typically a complex and time consuming process. Also, the roaming inter-networking process is complicated and uses a significant amount of resources (such as a public switched telephone network (PSTN) and GSM Mobile Application Part (MAP) sessions). For example, when a subscriber of a home PLMN is within a coverage area of a visited PLMN with which the home PLMN has a roaming agreement and a call is placed to a telephone number associated with that subscriber, the call is routed to the home PLMN. The home PLMN knows where the subscriber is roaming and forwards the call to the visited PLMN, which establishes the call. Due to the resources that expended to implement conventional roaming service, each home PLMN typically charges each such roaming subscriber a special inter-operator tariff (IOT) (also referred to here as a “roaming tariff”) for each call that is made and received using such conventional roaming service. Such roaming tariffs can be substantial relative to the fees charged for non-roaming service.

Also, when a visitor uses the international roaming service offered by a visited PLMN, subscribers of the visited PLMN still must include the country code when calling the visitor, even though the visitor is being serviced by the same visited PLMN as the subscribers and even though if visitor is in the same country as the subscribers.

To address these issues, some cellular operators offer a “local roaming number service” in which a visitor to a particular visited PLMN is provided with a temporary, local subscription and a temporary, local telephone number for use when that user is within a location area associated with the visited PLMN. The visitor, when in a location area associated with the visited PLMN, is then provided service under the local subscription, thereby avoiding roaming fees that would otherwise apply under the visitor's subscription with his or her home PLMN. Instead, service provided to the visitor in connection with the temporary, local subscription is typically billed using a prepaid billing plan. Also, when the visitor is being provided service under the local subscription, other subscribers of the visited PLMN are able to call the visitor by dialing the local telephone number assigned to the visitor by the visited PLMN (which does not require dialing a country code).

Typically, for a wireless operator to provide such local roaming number service, the network switching subsystem (NSS) of the wireless operator must be modified to include special functionality in the network switching subsystem (for example, by modifying the gateway mobile switching center (GMSC), visitor location register (VLR), and/or home location register (HLR)) to support such local roaming number service. However, wireless operators are typically reluctant to modify NSS functionality that is otherwise satisfactory just to add local roaming number service.

### SUMMARY

One embodiment is directed to a server. The server includes an interface to communicatively couple the server to parts of a first public land mobile network (PLMN). The server is configured to receive, from an operation support subsystem included in the first PLMN, information indicative of a location update performed for a visitor to the first PLMN and store an address associated with a visitor location register included in the first PLMN that is servicing the visitor. The server is further configured to act as a home location register in connection with providing local roaming number service to the visitor using a local roaming number assigned to the visitor by the server.

Another embodiment is directed to a wireless network. The wireless network comprises a visitor location register to store information about wireless devices that are located in a coverage area associated with the wireless network and a switching center to establish calls with wireless devices located in the coverage area associated with the wireless network. The wireless network further comprises a home location register to store information about subscribers for whom the wireless network is their home network and an operations and support subsystem that is configured to receive information indicative of location update events. The wireless network further comprises a local roaming server coupled to the operations and support subsystem to receive at least a portion of the information indicative of the location update events. The local roaming server is configured to do the following after a visitor enters the coverage area associated with the wireless network and successfully performs a location update: store an address associated with the visitor location register that is servicing the visitor and act as a home location register in connection with providing local roaming number service to the visitor using a local roaming number assigned to the visitor.

Another embodiment is directed to a method of providing local roaming number service to a visitor of a local public land mobile network (PLMN). The method comprises receiving, from an operations support subsystem, information indicative a successful location update performed for the visitor when the visitor enters a coverage area associated with the local PLMN. The method further comprises storing an address associated with a visitor location register included in the local PLMN that is servicing the visitor and acting as a home location register in connection with providing local roaming number service to the visitor.

Another embodiment is directed to an apparatus for of providing local roaming number service to a visitor of a local public land mobile network (PLMN). The apparatus comprises means for receiving, from an operations support subsystem, information indicative a successful location update performed for the visitor when the visitor enters a coverage area associated with the local PLMN and means for storing an address associated with a visitor location register included in the local PLMN that is servicing the visitor. The apparatus further comprises means for acting as a home location register in connection with providing local roaming number service to the visitor using a local roaming number assigned to the visitor.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a wireless communication system implementing local roaming number (LRN) service.

FIG. 2 is a block diagram illustrating how a location update is performed in the network of FIG. 1 for a visitor.

FIG. 3 is a flow chart of one embodiment of a method of manually registering for local roaming number (LRN) service provided by a visited PLMN.

FIG. 4 is a flow chart of one embodiment of a method of providing local roaming number (LRN) service to a visitor of a PLMN.

FIG. 5 illustrates the handling of a mobile terminated call (MTC) made to a LRN subscriber in the network of FIG. 1.

Like reference numbers and designations in the various drawings indicate like elements.

### DETAILED DESCRIPTION

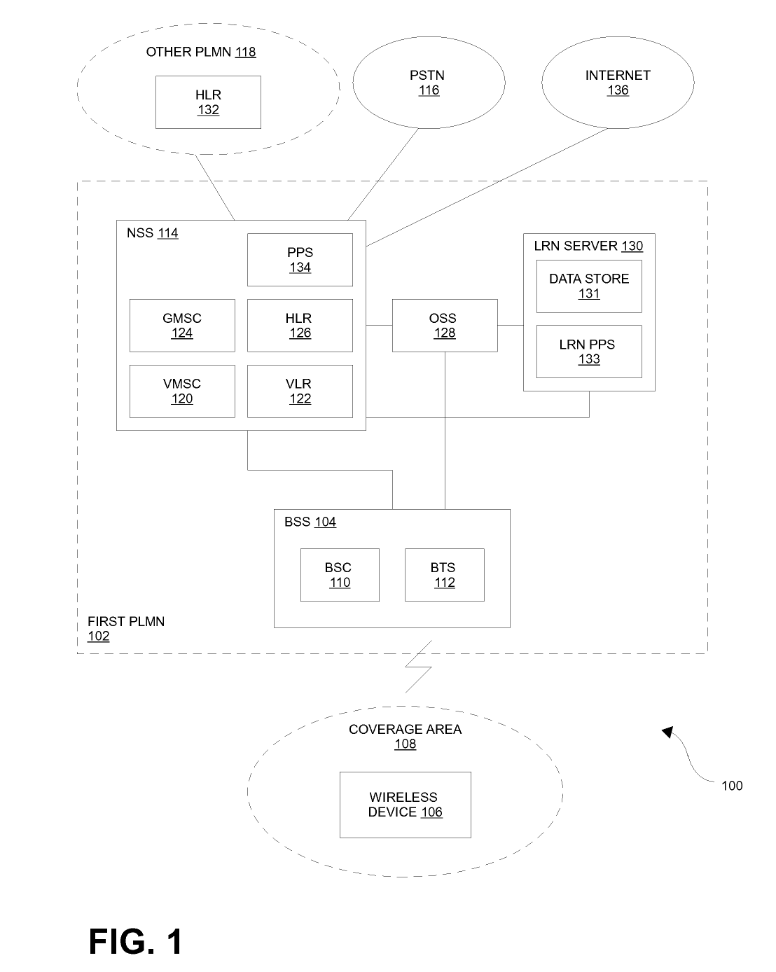

FIG. 1 is a block diagram of one embodiment of a wireless communication system 100 suitable for implementing the local roaming number (LRN) service described below. The communication system 100 is a part of a public land mobile network (PLMN) 102. The public land mobile network 102 is also referred to here as the “first” public land mobile network 102 or, in some contexts, the “local” or “visited” public land mobile network 102. The wireless communication system 100 is described here as being implemented in order to support one or more of the Global System for Mobile communication (GSM) family of telephony and data specifications and standards. It is to be understood, however, that other embodiments are implemented to support other wireless specifications or standards including, for example, one or more of the CDMA family of telephony and data standards (including, for example, the IS-95, CDMA2000, and EV-DO standards).

The first PLMN 102 comprises a base station subsystem 104. The base station subsystem 104 implements at least one air interface that enables it to communicate with at least one wireless device 106 located within a coverage area 108 associated with the base station subsystem 104. In the particular embodiment shown in FIG. 1, the wireless device 106 is a GSM mobile station (such as a mobile telephone or a personal digital assistant) that is able to at least make and receive telephone calls. In this embodiment, the BSS 104 supports at least one GSM telephony air interface that enables the BSS 104 (and the other elements of the first PLMN 102) to communicate with a wireless device 106 that is able to make and receive telephone calls.

The BSS 104 comprises base station controller (BSC) functionality 110 and base transceiver station (BTS) functionality 112. In the particular embodiment shown in FIG. 1, the BSC functionality 110 implements GSM base station controller functions including, for example, base station management (including radio channel allocation, call handovers among base stations, and base transceiver station configuration), software and alarm handling, and operations and maintenance support. Moreover, in some embodiments, the BSC functionality 110 includes or is communicative coupled to an appropriate network element or function (for example, a packet control unit (PCU)) for directing traffic to and from a data network (for example, the Internet 136 or another data network that is coupled to the Internet 136).

The particular embodiment shown in FIG. 1 supports at least one GSM air telephony interface. The BTS functionality 112 implements GSM base station functionality including, for example, one or more radio transceiver (TRXs), power amplifiers, combiners, duplexers, and antennas (and/or suitable interfaces to connect the BTS functionality 112 to one or more antennas). In some embodiments, the base station subsystem 104 further includes transcoding functionality. In other embodiments, transcoding occurs elsewhere in the PLMN 102.

In some embodiments, the BSC functionality 110 and the BTS functionality 112 are implemented in separate devices that communicate with one another using the GSM Abis interface over suitable communication links. In some implementations of such embodiments, the communication links comprise one or more time division multiplexing (TDM) communication links such as E1 or T1 communication links or a wide or local area network such as an Internet Protocol (IP) network. In other embodiments, at least a part of the BSC functionality 110 is implemented in the same device in which the BTS functionality 112 is implemented.

Although only a single BSS 104 and a single coverage area 108 are shown in FIG. 1, it is to be understood that the first PLMN 102 can include any number of base station subsystems 104 and each base station subsystem 104 can include multiple coverage areas.

The first PLMN 102 also comprises a network switching subsystem (NSS) 114. The NSS 114 is communicatively coupled to the base station subsystem 104. For example, in some embodiments, the NSS 114 is communicatively coupled to the base station subsystem 104 via one or more time division multiplexing (TDM) communication links such as E1 or T1 links. In other embodiments, the NSS 114 is communicatively coupled to the base station subsystem 104 via a wide or local area network such as an IP network. In other embodiments, the NSS 114 is communicatively coupled to the BSS 104 in other ways (for example, using wireless links such as satellite or microwave links or by integrating the NSS 114 (or portions thereof) and BSS 104 (or portions thereof) into the same device).

The NSS 114 is also communicatively coupled to a public switched telephone network (PSTN) 116 (for example, for voice communications) and to other public land mobile networks 118. For ease of explanation, only one PSTN 116 and one other PLMN 118 are shown in FIG. 1; however, it is to be understood that the NSS 114 will typically be communicatively coupled to more than one other PLMNs 118. The other PLMN 118 shown in FIG. 1 is also referred to here as the “second” PLMN 118 or, in some contexts, the “home” PLMN 118.

The NSS 114 implements switching functionality, authorizes subscribers, obtains and maintains subscriber information, and provides applications and call features to subscribers of the first PLMN 102 (such as call ringing, roaming, voice mail, short message service). In the particular embodiment shown in FIG. 1, the NSS 114 implements GSM network switching subsystem functionality. For example, in the embodiment shown in FIG. 1, the NSS 114 comprises a visitor mobile switching center (VMSC) 120 to implement GSM VMSC functionality for wireless devices 106 that are currently located within a coverage area 108 associated with the local PLMN 102. The VMSC 120 performs call processing and switching and mobility and handover handling for wireless devices 106 that are currently located within a coverage area 108 associated with the local PLMN 102.

The NSS 114 also includes visitor location register (VLR) 122 that implements GSM visitor location register functionality. Each separate coverage area 108 that is supported by the first PLMN 104 has one VMSC 120 and VLR 122 with which it is associated. The VLR 122 comprises a data store in which information about each subscriber who is currently in a coverage area 108 that is associated with the VLR 122 is stored. Such subscribers include subscribers who are subscribers of the first PLMN 104 and subscribers who are not subscribers of the first PLMN 104.

In the embodiment shown in FIG. 1, the NSS 114 further comprises a gateway mobile switching center (GMSC) 124 to implement GSM GMSC functionality for subscribers of the local PLMN 102 (including LRN subscribers described bellows). More specifically, when a subscriber of the local PLMN 102 is being called, the GMSC 124 is contacted in order to determine which VMSC is servicing that subscriber at that moment.

The NSS 114 includes a home location register (HLR) 126 for the first PLMN 102 that implements GSM home location register functionality for the first PLMN 102. The HLR 126 comprises a data store in which information about each “standard” subscriber of the first PLMN 102 is stored (such as which VMSC (if any) is servicing that subscriber at the moment). As used herein, a standard subscriber of the first PLMN 102 is a subscriber for whom the first PLMN 104 is his or her home PLMN. Typically, there is one logical HLR per PLMN, although the HLR maybe implemented using multiple physical HLRs.

In the embodiment shown in FIG. 1, the NSS 114 also comprises other standard GSM functionality (not shown), such as an authentication center (AUC) to implement GSM authentication functionality, a prepaid server (PPS) 134 to implement standard GSM prepaid functionality, an audio announcement server (AAS) to provide call and prepaid voice announcements to users of the PLMN 102, a short message service (SMS) server to implement GSM short message service functionality, and a voice mail server (VMS) to provide voice mail services to subscribers of the first PLMN 102.

In this embodiment, the VMSC 120 and each associated BSS 104 communicate with each other using the GSM A interface. The VMSC 102 and the VLR 122 communicate with each other using the GSM MAP-B interface. The VMSC 120 and the GMSC 124 communicate with each other using the ISUP interface. The GMSC 124 and the HLR 126 communicates with each other using the GSM MAP-C interface. The VLR 122 and the HLR 126 communicate with each other using the GSM MAP-D interface.

The first PLMN 102 further comprises an operation and support subsystem system (OSS) 128. The OSS 128 is connected to the various components of the NSS 114 and the BSS 104 in order to control and monitor the GSM system. In particular, the OSS 128 implements the standard GSM OSS functions such administration and commercial operation (subscription, end terminals, charging and statistics), security management, network configuration, operation and performance management, and maintenance tasks. The OSS 128 uses a suitable interface (such as the telecommunication management network (TMN) Q3 interface or the Multi-Technology Operations Systems Interface (MTOSI) interface) to communicate with other entities in the first PLMN 102 and entities external to the first PLMN 102.

In the particular embodiment shown in FIG. 1, the first PLMN 102 further comprises a local roaming number (LRN) server 130. The LRN server 130 is used to provide LRN service within the first PLMN 102 as described below. As described in more detail below, the LRN server 130 implements LRN service within the first PLMN 102 without requiring changes to the NSS 114 (which can be implemented using “standard” GSM NSS functionality).

The LRN server 130 comprises a data store 131 in which information about each LRN subscriber is stored. As used herein, a “LRN subscriber” is a subscriber whose home PLMN 118 is not the first PLMN 102 but to whom the LRN server 130 (and the first PLMN 102) provides LRN service as described here. The LRN server 130 assigns a local telephone number (also referred to here as a “local roaming number”) to each LRN subscriber that the LRN subscriber can use to receive calls when in a location area 108 of the first PLMN 102. The LRN sever 130, as a part of the LRN subscriber information it stores in its data store 131 for each LRN subscriber, stores the IMSI and home mobile subscriber ISDN number (MSISDN) for that LRN subscriber, which the LRN server 130 use as keys for that subscriber's record in the data store 131. As used herein, the “home MSISDN” refers to the MSISDN that is assigned by a visitor's home PLMN 118. Moreover, in the particular embodiment shown in FIG. 1, the LRN server 130 also implements pre-paid service functionality 133 so that the LRN service can be billed using a pre-paid billing plan.

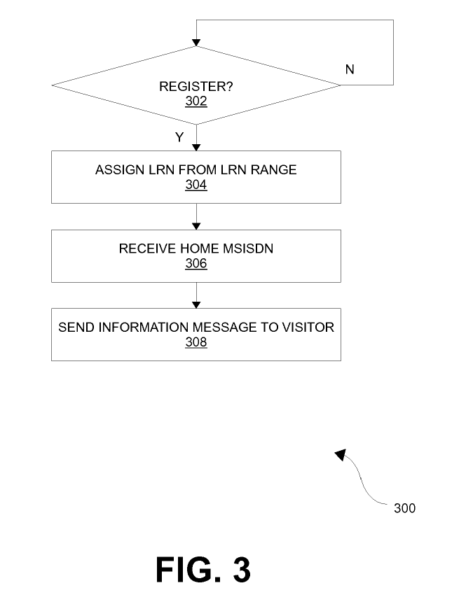

As described in detail below, the LRN server 130 obtains the IMSI and home MSISDN for the visitor from information indicative of a location update event. Such information is sent to the LRN server 130 by the OSS 128 when the visitor enters a coverage area 108 associated with the first PLMN 102 and performs a location update. Also, as described below in connection with FIG. 3, someone who is going to visit the first PLMN 102 in the future can manually register with the LRN server 130 ahead of time over the Internet or over the phone using the PPS functionality 133 in the LRN server 130. In this case, the user enters the user' home MSISDN for the wireless device 106 the user will use when visiting the first PLMN 102. Then, the first time the user enters a coverage area 108 associated with the first PLMN 102 and performs a location update, the OSS 128 will send the IMSI and home MSISDN for the user to the LRN server 130, which will capture the IMSI for the user and store it in the user's LRN subscriber record.

The LRN server 130 assigns an MSISDN number from a range of MSISDN numbers that is assigned to the PLMN 102 by a relevant authority and that the PLMN 102 specifically sets aside for use for assigning local roaming numbers. This range of MSISDN numbers is also referred to here as the “LRN range.” The LRN server 130 acts as the HLR for the any MSISDN number that falls within the LRN range for the first PLMN 102. The GMSC 124 is configured to consider the address (that is, the E.164 address) of the LRN sever 130 as the HLR for MSISDN numbers falling within the LRN range. This configuration of the GMSC 124 is done using the standard MSISDN-to-HLR routing functionality required by the GSM standards and does not require any special changes to the GMSC 124 for it to support LRN server in the first PLMN 102.

In the particular embodiment shown in FIG. 1, the LRN server 130 is coupled to the OSS 128 using the TMN Q3 interface (or the MTOSI interface), is coupled to the VLR 122 using the GSM MAP-D interface, and is coupled to the GMSC 124 using the GSM MAP-C interface.

In the embodiment shown in FIG. 1, payment for the LRN service can be implemented using a pre-paid billing plan where the visitor must purchases minutes before the visitor is able to use the LRN service. In this embodiment, the pre-paid server 134 is used to manage the establishment of prepaid accounts for LRN subscribers. From the perspective of the pre-paid server 134, a LRN subscriber is just another type of pre-paid subscriber. A pre-paid account is established for a visitor when the LRN server 130 assigns a local roaming number to the visitor from the LRN range. The LRN server 130 uses a standard interface provided by the PPS server 134 to communicate LRN subscriber information (such as the visitor's IMSI and local roaming MSISDN number) to the PPS 134. The PPS 134 uses the LRN subscriber information to establish a pre-paid account for that visitor. The visitor would then need to charge the pre-paid account using, for example, an interactive voice response (IVR) system or a website accessible via the Internet 136 to provide a credit card or calling card number. In other embodiments, visitors are billed for using the LRN service in other ways.

In the embodiment shown in FIG. 1, each LRN subscriber's account will expire at some point, after which the LRN assigned to that subscriber can be assigned to a different visitor. For example, in one implementation of such an embodiment, a LRN subscriber account expires after a predetermined period of inactivity or predetermined period of having a zero balance. Moreover, there maybe different conditions upon which such LRN subscriber accounts expire. For example, a newly created LRN subscriber account can be set to expire after a relatively short period of inactivity (for example, after 48 hours of non-use), whereas LRN subscriber accounts that have been “charged” and used can be set to expire after a longer period of inactivity (for example, after 60 days of non-use). Other LRN policies can be used for managing LRN subscriber accounts.

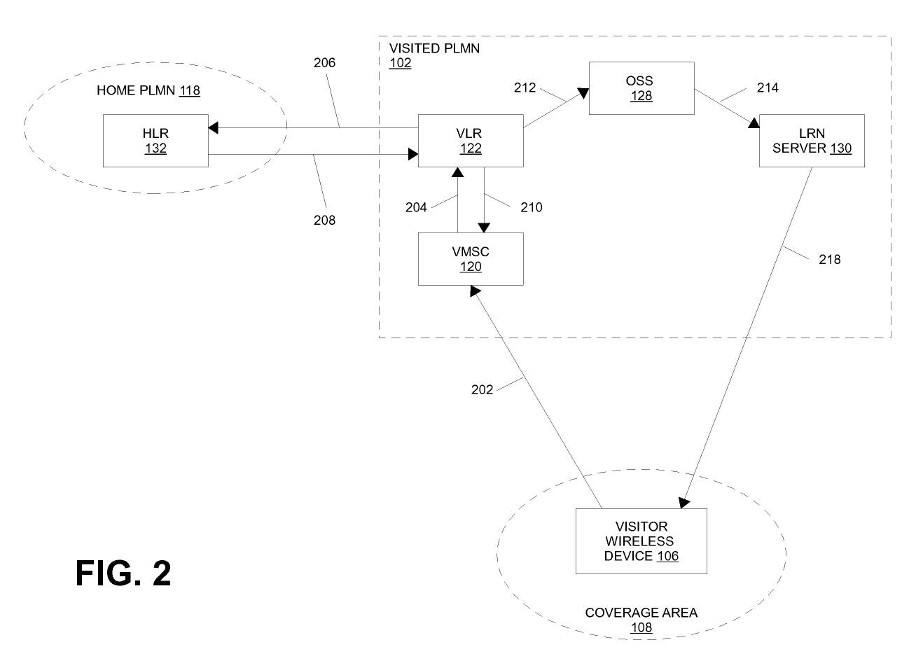

FIG. 2 is a block diagram illustrating how a location update is performed in the network 100 of FIG. 1 for a visitor. When a visitor (and associated wireless device 106) enters a location area 108 associated with the first PLMN 102, the visitor's wireless device 106 establishes a signaling connection with a BSS 104 serving that location area 108 and performs any needed authentication. The wireless device 106 then initiates the standard GSM location update process. That is, the wireless device 106 sends a location request message 202, which is forwarded by the BSS 104 (not shown in FIG. 2) to the VMSC 120 for the location area 108. The VMSC 120 forwards the location update request 204 to the VLR 122. The VLR 122 inspects the location update request 204 to learn that the location area that the visitor was previously located in was handled by a different MSC/VLR. In response to this, the VLR 122 sends a location update message 206 to the “home” HLR 132 for the visitor. The home HLR 132 for the visitor authenticate the visitor's wireless device 106, records the address of the VLR 122 (for example, the E.164 number assigned to the VLR 122) and the current location area 108 of the visitor. The home HLR 132 of the visitor then sends an “insertSubscriberData” message 208 to the VLR 122 with the visitor's subscriber information. The home HLR 132 of the visitor also sends a message (not shown) to the MSC/VLR that was previously serving the visitor indicating that the visitor should be de-registered from that MSC/VLR. The VLR 122 then sends a location update acknowledgement message 210 to the VMSC 120.

As a part of the standard location update process, the OSS 128 of the visited PLMN 102 will be informed of the location update for the visitor. Specifically, in the particular embodiment shown in FIG. 2, the VLR 122 sends the OSS 128 a location update event record 212 in accordance with GSM Standard 12.05 titled “Subscriber related event and call data” (also referred to here as the “GSM 12.05 Standard”). The location update event record 214 that is provided to the LRN server 130 by the OSS 128 includes, among other things, the IMSI for the visitor and the address of the VLR 122 that generated the location update event record.

In this embodiment, the OSS 128 is configured to send the corresponding location update event record 214 to the LRN server 130 when a visitor enters the location area 108 of the first PLMN 102 and performs a location update. This configuration is implemented using the Q3 interface that is provided by the OSS 128. In this way, the LRN server 130 learns of the visitor's presence in the location area 108 of the first PLMN 102 (as well information about the visitor such as the IMSI of the visitor's wireless device 106) without having to modify the standard elements of the NSS 114. As described in more detail below, the LRN server 130 sends an informational message 218 to the visitor (using, for example, a SMS message).

FIG. 3 is a flow chart of one embodiment of a method 300 of manually registering for local roaming number (LRN) service provided by a visited PLMN. The particular embodiment of method 300 shown in FIG. 3 is described here as being implemented using the system 100 of FIG. 1 (though other embodiments are implemented in other ways).

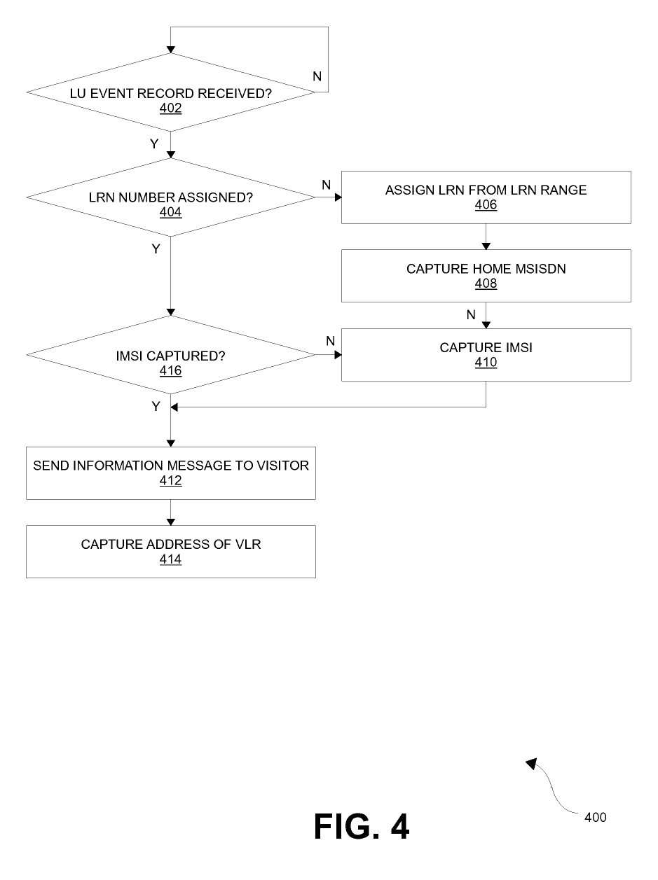

When someone who is going to visit the first PLMN 102 in the future accesses the PPS functionality 133 in the LRN server 130 in order to register (checked in block 302), the PPS functionality 133 will create a LRN subscriber record for that visitor in the data store 131 maintained by the LRN server. In one implementation of such an embodiment, visitors are able to access the PPS functionality 133 of the LRN server 130 via the Internet (in which case the PPS functionality 133 would include or be coupled to appropriate Web server functionality) or over the phone (in which the PPS functionality 133 would include or be coupled to appropriate IVR functionality). The LRN server 130 assigns a local roaming number to the visitor (block 304). The LRN server 130 selects a local roaming number for the visitor from the LRN range that the LRN server 130 uses for assigning local roaming numbers. The LRN server 130 also prompts visitor to supply the visitor's home MSISDN. The LRN server 130 then receives the entered home MSISDN number and stores it in the visitor's LRN subscriber record along with the local roaming number assigned to the visitor. It is noted that at this time, the LRN subscriber record does not contain the visitor's IMSI, which will be obtained when the visitor first enters a coverage area associated with the first PLMN 102 and performs a location update as described below in connection with FIG. 4.

After the LRN server 130 assigns a local roaming number to the visitor and receive the visitor's home MSISDN, the LRN server 130 sends the visitor an introduction message informing the visitor of LRN service provided by the first PLMN 102 and the local roaming number assigned to the visitor by the LRN server 130 (block 308). In one implementation, of such an embodiment, a short message service (SMS) message is sent to the visitor's wireless device 106 (the SMS message being address to the visitor's home MSISDN). The introduction message also includes information about how the visitor can pay for the LRN service. For example, the introduction message includes a telephone number or website that the visitor can call or access to provide a credit card number or pre-paid calling card number to pay for use of the LRN service.

FIG. 4 is a flow chart of one embodiment of a method 400 of providing local roaming number (LRN) service to a visitor of a PLMN. The particular embodiment of method 400 shown in FIG. 4 is described here as being implemented using the system 100 of FIG. 1 (though other embodiments are implemented in other ways).

When the LRN server 130 receives a location update event record from the OSS 128 for a successful location update performed for a visitor to the first PLMN 102 (checked in block 402), the LRN server 130 checks if the visitor already has a local roaming number assigned to it by the first PLMN 102 (block 404). The LRN server 130 does this using the home MSISDN and International Mobile Subscriber Identity (IMSI) number that are included in the location update event record provided to it. The home MSISDN and IMSI number are assigned by the visitor's home PLMN 118. The IMSI number is typically stored in a SIM module used in that subscriber's wireless device 106. The wireless device 106 provides the visitor's home MSISDN and IMSI to the VMSC 120 when it performs the location update. As noted above, in this particular embodiment, the data store 131 used by the LRN server 130 to store LRN subscriber information uses each LRN subscriber's home MSISDN and IMSI as keys for the LRN subscriber records store therein.

If the visitor does not have a local roaming number assigned to it by the first PLMN 102 (also referred to here as the “visited” PLMN 102), the LRN server 130 assigns a local roaming number to the visitor (block 406). The LRN server 130 selects a local roaming number for the visitor from the LRN range that the LRN server 130 uses for assigning local roaming numbers.

The LRN server 130 also captures the visitor's home MSISDN number (block 408) and IMSI (block 410), which the LRN server 130 stores in the visitor's LRN subscriber record along with the local roaming number assigned to the visitor. The visitor's home MSISDN and IMSI are captured by the LRN server 130 from the location update event record provided to it.

After the LRN server 130 assigns a local roaming number to the visitor and has captured the visitor's home MSISDN and IMSI, the LRN server 130 sends the visitor an introduction message informing the visitor of LRN service provided by the first PLMN 102 and the local roaming number assigned to the visitor by the LRN server 130 (block 412). In one implementation, of such an embodiment, a short message service (SMS) message is sent to the visitor's wireless device 106 (the SMS message being address to the visitor's home MSISDN). The introduction message also includes information about how the visitor can pay for the LRN service. For example, the introduction message includes a telephone number or website that the visitor can call or access to provide a credit card number or pre-paid calling card number to pay for use of the LRN service.

The LRN server 130 also captures the address of the VLR 122 that generated the location update event record (block 414). The LRN server 130 uses this address when it acts as an HLR for the visitor and needs to send a “provideRoamingNumber” (PRN) message to the VLR 122 in response to receiving a “sendRoutingInfo” (SRI) message received from some other GMSC.

In the case where the visitor was previously assigned a local roaming number by the LRN server 130, the LRN server 130 checks if the vistor's IMSI has been captured and stored in the visitor's LRN subscriber record (block 416). If the visitor's has not captured (for example, because the user manually registered as described above in connection with FIG. 3), the LRN server 130 captures the visitor's IMSI (block 410), which the LRN server 130 stores in the visitor's LRN subscriber record. The visitor's IMSI are captured by the LRN server 130 from the location update event record provided to it. Then, the LRN server sends an introduction message to the visitor's wireless device 106 (block 412) and captures the address of the VLR 122 that generated the location update event record (block 414) as described above.

In the case where the visitor was previously assigned a local roaming number by the LRN server 130 and the LRN server 130 has already captured the visitor's IMSI, the LRN server sends an introduction message to the visitor's wireless device 106 (block 412) and captures the address of the VLR 122 that generated the location update event record (block 414) as described above. In this case, the introduction message serves as a reminder of the pertinent elements of LRN service provided by the visited PLMN 102.

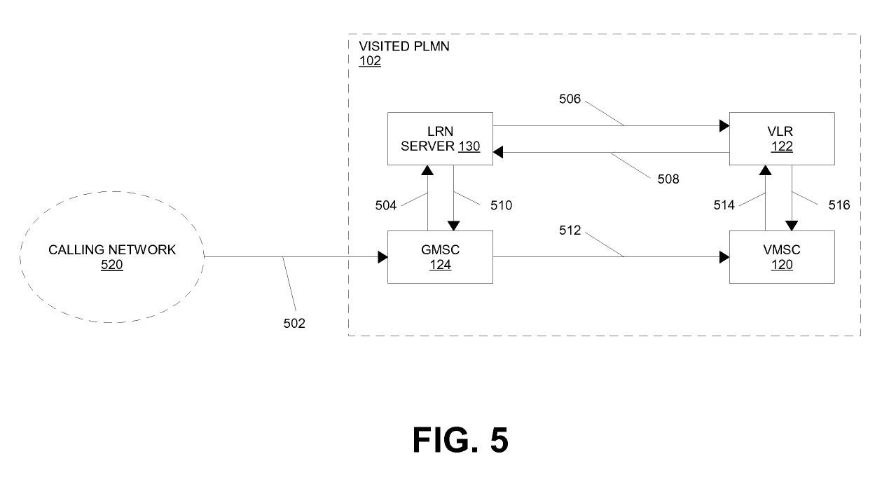

FIG. 5 illustrates the handling of a mobile terminated call (MTC) made to a LRN subscriber in the network 100 of FIG. 1. In this example, when a MTC call is made to a visitor to the visited PLMN 102 using the visitor's local roaming number MSISDN, an ISUP IAM message 502 is sent from the calling network 520. The IAM message 502 contains the MSISDN of the called party (that is, the LRN MSISDN number of the visitor). The IAM message 502 is routed to the GMSC 124 of the visited network 102 using standard SS7 routing techniques based on the MSISDN of the called party.

The GMSC 124 receives the IAM message 502. Based on the MSISDN contained in the received IAM message 502, the GMSC 124 determines that the MSISDN is a LRN MSISDN number (because it falls within the LRN range of MSISDN numbers) and sends a send routing information (SRI) message 504 to the HLR for MSISDN numbers falling within the LRN range, which is the LRN server 130. The SRI message 504 is sent to the LRN server 130 in order to locate the visitor within the visited PLMN 102 (that is, by finding the VMSC and VLR that are currently servicing the visitor).

The LRN server 130 locates the LRN subscriber associated with the called MSISDN number included in the SRI message 504 by searching its data store 131 using the called MSISDN number. If the LRN subscriber associated with the called MSISDN number is not within a coverage area associated with the visited PLMN 102, the calls fails. If the LRN subscriber associated with the called MSISDN number is actually within a coverage area associated with the visited PLMN 102, the LRN subscriber's record in the LRN server's data store 131 will include the address of the VLR 122 that is currently servicing that LRN subscriber. The LRN server 130 uses the IMSI of the LRN subscriber to send a provide-roaming-number (PRN) message 506 to the VLR 122 that is currently servicing that LRN subscriber. The VLR 122 associates the IMSI of the LRN subscriber indicated in the PRN message 506 with a temporary mobile station roaming number (MSRN), which is returned to the LRN server 130 in a PRN acknowledgment message 508. The LRN server 130 then returns the MSRN to the GMSC 124 in an SRI acknowledgment message 510.

The GMSC 124 then uses the MSRN to forward the call to the V-MSC 120 that is associated with the VLR 122 servicing the called LRN subscriber. This is possible as the MSRN not only temporarily identifies the called LRN subscriber in the VLR 122 but also uniquely identifies the VMSC 120 to external switches. To forward the call from the GMSC 124 to the VMSC 120, an IAM message 512 is used again, which instead of the called LRN MSISDN contains the MSRN to identify the LRN subscriber. The VMSC 120 requests the incoming call profile for the called LRN subscriber by sending a SIFIC message 514 to the VLR 122 and receives the profile from the VLR 122 in a Paging message 516 sent by the VLR 122. The VMSC 120 is then able to setup the call with the LRN subscriber in the normal manner.

In the particular embodiment described here in connection with FIG. 1, a visitor makes calls in the normal manner as a roamer (subject to the normal roaming tariff for mobile originated calls, which is typically less than the roaming tariff that applies to calls received by the visitor using his or her home MSISDN).

The LRN server 130 described above is able to provide LRN service within a visited PLMN 102 without requiring changes to standard NSS 114 elements. Also, using the LRN server 130 described above to provide LRN service within a visited PLMN 102 enables a LRN subscriber's to make use of the LRN service while still being able to receive calls made to the subscriber's regular home MSISDN number.

The functionality described here as being implemented by the LRN server 130 can be implemented in various ways. For example, the LRN server 130 can implemented as software that executes on a server. Such a server, for example, can comprise one or more programmable processors for executing the software and memory for storing the program instructions and any related data. The software comprises program instructions that are stored (or otherwise embodied) on an appropriate storage medium or media (such as flash memory) from which at least a portion of the program instructions are read by the programmable processor for execution thereby. Such a server also includes appropriate interfaces to communicatively couple the server to the other elements of the PLMN.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A server comprising:
an interface to communicatively couple the server to parts of a first public land mobile network (PLMN);
wherein the server is configured to:
receive, from an operation support subsystem included in the first PLMN, information indicative of a location update performed for a visitor to the first PLMN;
store an address associated with a visitor location register included in the first PLMN that is servicing the visitor; and
act as a home location register in connection with providing local roaming number service to the visitor using a local roaming number assigned to the visitor by the server.

2. The server of claim 1, wherein the server acts as the home location register in connection with providing local roaming number service to the visitor by:
receive a send routing information (SRI) message from a switching center, the SRI message being associated with a call made to the local roaming number;
determine if the visitor associated with the local roaming number is within a coverage area associated with the first PLMN;
if the visitor associated with the local roaming number is within a coverage area associated with the first PLMN:
send a provide-roaming-number (PRN) message to the visitor location register that is currently servicing that visitor;
receive a PRN acknowledgment message from the visitor location register that is currently servicing that visitor, the PRN acknowledgment including a temporary mobile station roaming number (MSRN) for the visitor;
send an SRI acknowledgment message to the switching center that sent the SRI message, the SRI acknowledgment message contains the MSRN for the visitor.

3. The server of claim 1 further comprising software operable to implement at least a portion of the functionality supported by the server.

4. The server of claim 1, wherein the server is further configured to assign the local roaming number to the visitor for use in connection with the local roaming service when the visitor does not have a local roaming number assigned thereto.

5. The server of claim 4, wherein the server is configured to assign the local roaming number to the visitor for use in connection with the local roaming service during a manual registration process.

6. The server of claim 5, wherein the manual registration process is performed over the Internet or using a phone.

7. The server of claim 5, wherein the server is configured to receive a home telephone number assigned by a home PLMN for the visitor during the manual registration process and to receive an identifier associated with a wireless device used by the visitor when the visitor visits the first PLMN.

8. The server of claim 4, wherein the server is configured to assign the local roaming number to the visitor for use in connection with the local roaming service when the visitor visits the first PLMN.

9. The server of claim 8, wherein the server is configured to receive a home telephone number assigned by a home PLMN for the visitor during and an identifier associated with a wireless device used by the visitor when the visitor visits the first PLMN.

10. The server of claim 4, wherein the server is configured to assign the local roaming number to the visitor for use in connection with the local roaming service by selecting the local roaming number from a range of local roaming numbers allocated to the server.

11. The server of claim 1, wherein the server is further configured to send an introduction message to the visitor in response to receiving the information indicative of the location update performed for the visitor.

12. The server of claim 1, wherein the interface comprises a Q3 interface to communicate with the operations support subsystem, a MAP-D interface to communicate with the visitor location register, and a MAP-C interface to communicate with switching centers.

13. The server of claim 1, wherein the server is configured to act as a home location register in connection with providing local roaming number service to the visitor by doing the following in connection with a call that is made to the visitor using the local roaming number assigned thereto:
in response to receiving a message from a switching center requesting routing information related to the local roaming number assigned to the visitor, sending a message to the visitor location register servicing the visitor requesting that the visitor location register provide a mobile station roaming number (MSRN) for the visitor and forwarding the MSRN to the switching center.

14. The server of claim 1, wherein the information indicative of the location updates comprises location update event records.

15. A wireless network comprising:
a visitor location register to store information about wireless devices that are located in a coverage area associated with the wireless network;
a switching center to establish calls with wireless devices located in the coverage area associated with the wireless network;
a home location register to store information about subscribers for whom the wireless network is their home network;
an operations and support subsystem that is configured to receive information indicative of location update events; and
a local roaming server coupled to the operations and support subsystem to receive at least a portion of the information indicative of the location update events, wherein the local roaming server is configured to do the following after a visitor enters the coverage area associated with the wireless network and successfully performs a location update:
store an address associated with the visitor location register that is servicing the visitor; and
act as a home location register in connection with providing local roaming number service to the visitor using a local roaming number assigned to the visitor.

16. The wireless network of claim 15, wherein the local roaming server acts as the home location register in connection with providing local roaming number service to the visitor by:
receiving a send routing information (SRI) message sent from a gateway switching center, the SRI message being associated with a call made to the local roaming number;
determining if the visitor associated with the local roaming number is within a coverage area associated with the wireless network;
if the visitor associated with the local roaming number is within a coverage area associated with the wireless network:
sending a provide-roaming-number (PRN) message to the visitor location register that is currently servicing that visitor;
receiving a PRN acknowledgment message from the visitor location register that is currently servicing that visitor, the PRN acknowledgment including a temporary mobile station roaming number (MSRN) for the visitor; and
sending an SRI acknowledgment message to the gateway switching center that sent the SRI message, the SRI acknowledgment message contains the MSRN for the visitor.

17. The wireless network of claim 15, wherein the local roaming number server is further configured to assign the local roaming number to the visitor for use in connection with the local roaming service when the visitor does not have a local roaming number assigned thereto.

18. The wireless network of claim 17, wherein the server is configured to assign the local roaming number to the visitor for use in connection with the local roaming service during a manual registration process.

19. The wireless network of claim 18, wherein the manual registration process is performed over the Internet or using a phone.

20. The wireless network of claim 18, wherein the server is configured to receive a home telephone number assigned by a home PLMN for the visitor during the manual registration process and to receive an identifier associated with a wireless device used by the visitor when the visitor visits the first PLMN.

21. The wireless network of claim 17, wherein the server is configured to assign the local roaming number to the visitor for use in connection with the local roaming service when the visitor visits the wireless network.

22. The wireless network of claim 21, wherein the server is configured to receive a home telephone number assigned by a home wireless network for the visitor during and an identifier associated with a wireless device used by the visitor when the visitor visits the wireless network.

23. The wireless network of claim 17, wherein the local roaming number server is configured to assign the local roaming number to the visitor for use in connection with the local roaming service by selecting the local roaming number from a range of local roaming numbers allocated to the local roaming number server.

24. The wireless network of claim 15, wherein the local roaming number server is further configured to send an introduction message to the visitor after the visitor enters the coverage area associated with the wireless network and successfully performs the location update.

25. The wireless network of claim 15, wherein the local roaming number server is configured to implement a Q3 interface to communicate with the operations support subsystem, to implement a MAP-D interface to communicate with the visitor location register, and a MAP-C interface to communicate with switching centers.

26. The wireless network of claim 15, wherein the local roaming number server is configured to act as a home location register in connection with providing local roaming number service to the visitor by doing the following in connection with a call that is made to the visitor using the local roaming number assigned thereto:
in response to receiving a message from a switching center requesting routing information related to the local roaming number assigned to the visitor, sending a message to the visitor location register servicing the visitor requesting that the visitor location register provide a mobile station roaming number (MSRN) for the visitor and forwarding the MSRN to the switching center.

27. The wireless network of claim 15, wherein the information indicative of location updates comprises location update event records.

28. A method of providing local roaming number service to a visitor of a local public land mobile network (PLMN), the method comprising:
receiving, from an operations support subsystem, information indicative a successful location update performed for the visitor when the visitor enters a coverage area associated with the local PLMN;
storing an address associated with a visitor location register included in the local PLMN that is servicing the visitor; and
acting as a home location register in connection with providing local roaming number service to the visitor.

29. The method of claim 28, wherein acting as the home location register in connection with providing local roaming number service to the visitor comprises:
receiving a send routing information (SRI) message sent from a switching center, the SRI message being associated with a call made to the local roaming number;
determining if the visitor associated with the local roaming number is within a coverage area associated with the local PLMN;
if the visitor associated with the local roaming number is within a coverage area associated with the local PLMN:
sending a provide-roaming-number (PRN) message to the visitor location register that is currently servicing that visitor;
receiving a PRN acknowledgment message from the visitor location register that is currently servicing that visitor, the PRN acknowledgment including a temporary mobile station roaming number (MSRN) for the visitor; and
sending an SRI acknowledgment message to the switching center that sent the SRI message, the SRI acknowledgment message contains the MSRN for the visitor.

30. The method of claim 28, further comprising assigning the local roaming number to the visitor for use in connection with the local roaming service when the visitor does not have a local roaming number assigned thereto.

31. The method of claim 30, wherein assigning the local roaming number to the visitor comprises selecting the local roaming number from a range of local roaming numbers allocated to the server.

32. The method of claim 28, further comprising sending an introduction message to the visitor in response to receiving the information indicative of the successful location update performed for the visitor.

33. The method of claim 28, wherein acting as the home location register in connection with providing local roaming number service to the visitor comprises doing the following in connection with a call that is made to the visitor using the local roaming number assigned thereto:
in response to receiving a message from a switching center requesting routing information related to the local roaming number assigned to the visitor, sending a message to the visitor location register servicing the visitor requesting that the visitor location register provide a mobile station roaming number (MSRN) for the visitor and forwarding the MSRN to the switching center.

34. Apparatus for of providing local roaming number service to a visitor of a local public land mobile network (PLMN), the apparatus comprising:
means for receiving, from an operations support subsystem, information indicative a successful location update performed for the visitor when the visitor enters a coverage area associated with the local PLMN;
means for storing an address associated with a visitor location register included in the local PLMN that is servicing the visitor; and
means for acting as a home location register in connection with providing local roaming number service to the visitor using a local roaming number assigned to the visitor.

35. The apparatus of claim 34, wherein the means for acting as the home location register in connection with providing local roaming number service to the visitor using the local roaming number assigned to the visitor comprises:
means for receiving a send routing information (SRI) message sent from a switching center, the SRI message being associated with a call made to the local roaming number;
means for determining if the visitor associated with the local roaming number is within a coverage area associated with the local PLMN;
means for, if the visitor associated with the local roaming number is within a coverage area associated with the local PLMN,
sending a provide-roaming-number (PRN) message to the visitor location register that is currently servicing that visitor;
receiving a PRN acknowledgment message from the visitor location register that is currently servicing that visitor, the PRN acknowledgment including a temporary mobile station roaming number (MSRN) for the visitor; and
sending an SRI acknowledgment message to the switching center that sent the SRI message, the SRI acknowledgment message contains the MSRN for the visitor.
